(19) United States
(12) Patent Application Publication
(10) Pub. No.: US 2020/0031458 A1
(43) Pub. Date: Jan. 30, 2020

(54) Unmanned Aerial Vehicle with Thrust Decoupling, Active Wing Loading, Omnidirectional Lift Control and/or Vibration Management

(71) Applicants: Mark E Strauss, Old Greenwich, CT (US); Steven J. Bofill, New Rochelle, NY (US)

(72) Inventors: Mark E Strauss, Old Greenwich, CT (US); Steven J. Bofill, New Rochelle, NY (US)

(21) Appl. No.: 16/522,387

(22) Filed: Jul. 25, 2019

Related U.S. Application Data
(60) Provisional application No. 62/702,999, filed on Jul. 25, 2018.

(51) Int. Cl. B64C 27/20; B64C 1/22; B64C 27/00; B64C 29/02

(52) U.S. Cl. CPC B64C 27/20; B64C 1/22; B64C 27/001; B64C 29/02; B64C 2201/141; B64C 2201/048; B64C 2201/108; B64C 2201/128; B64C 2201/027

(57) ABSTRACT

An aerial vehicle, such as an unmanned aerial vehicle, includes a fuselage having a forward end, an aft end, and a duct extending between said forward end and said aft end, said duct being oriented along a longitudinal axis of said fuselage; a primary propulsion unit mounted within said duct and generating lift for upward and downward motion while said fuselage is in a substantially vertical orientation and thrust for forward motion while said fuselage is in a substantially horizontal orientation; a plurality of airfoils each having a proximal end attached at opposite sides of the fuselage, said airfoils providing lift during forward motion of said fuselage; and a plurality of secondary propulsion units generating thrust to tilt the fuselage between said substantially vertical orientation and said substantially horizontal orientation.

### CROSS-REFERENCE TO RELATED APPLICATIONS

This application claims priority to U.S. Provisional Application No. 62/702,999 filed on Jul. 25, 2018.

### TECHNICAL FIELD

This present invention relates to unmanned aerial vehicles, uninhabited aerial vehicles, and drones (collectively “UAVs”). More specifically, the present teachings relate to UAVs having vertical takeoff and landing (VTOL) capabilities, hovering capability, and both low-speed and high-speed maneuverability, as well as to guidance/navigation/control systems for such UAVs.

### BACKGROUND

An unmanned aerial vehicle, uninhabited aerial vehicle, or drone (collectively “UAV”), is a powered, heavier-than-air, aerial vehicle that does not carry a human operator, or pilot, and which uses aerodynamic forces to provide vehicle lift, can be expendable or reusable, and can carry a payload. A UAV can operate in a remote-control mode, in an autonomous mode, or in a partially autonomous mode. When the UAV operates in a remote-control mode, a pilot or operator that is at a remote location can control the vehicle via commands that are sent through a wireless link. When the UAV operates in autonomous mode, the vehicle typically moves based on pre-programmed navigation waypoints, dynamic automation systems, or a combination of these. Further, some UAVs can operate in both a remote-control mode and an autonomous mode, and in some instances may do so simultaneously.

Advancements in autonomous aerial vehicle technology are opening up new possibilities for use of UAVs in both civilian and military situations where the use of manned vehicles (e.g., ground vehicles, aircraft, watercraft) is not appropriate, feasible, efficient, and/or cost-effective. One particular situation with increasing interest in UAV application involves payload and package delivery. The main focus has been using UAVs in the form of small rotor-based vertical takeoff and landing (VTOL) aircraft (e.g., quadcopters, multicopters) for carrying and delivering payloads. While particularly suited to take off and landing in confined spaces, the use of rotor-based UAVs to deliver payloads to landing sites, such as residential addresses, has several drawbacks. For example, rotor-based UAVs are limited in the amount of lift that can be generated by the rotors and are restricted to carrying only small and relatively light-weight payloads. The rotors are also limited in the amount of thrust that can be generated for translational flight. As a result, rotor-based UAVs are not able to travel at high speeds and for long distances, which is possible with wing-type UAVs. Also, rotor-based UAVs have limitations when operating in confined areas due to the exposed rotors rotating above the fuselage.

Winged UAVs also drawbacks, especially with respect to payload delivery applications. For example, since winged UAVs require forward motion to maintain lift and therefore are not capable of hovering over a fixed spatial point. Winded UAVs are also not as maneuverable as rotor-based UAVs. As a result, winged UAVs are not very good at delivering payloads in confined spaces. Further, winged UAVs cannot take-off and land vertically. Instead, winged UAVs require elaborate launch and retrieval equipment, or require a runway.

Thus, there exists a need in the art for an aerial vehicle which provides increased lift capabilities during takeoff and/or landing and increased propulsive capabilities during forward flight. Such a system would enable carrying heavy payloads (e.g., packages) over long distances for delivery to/from confined spaces.

### SUMMARY

The needs set forth herein as well as further and other needs and advantages are addressed by the present embodiments, which illustrate solutions and advantages described below.

It is an object of the present teachings to remedy the above drawbacks and shortcomings associated with prior art unmanned aerial vehicles. Herein, the terms “unmanned aerial vehicle” and “UAV” are intended to refer to unmanned aerial vehicles, uninhabited aerial vehicles, and drones.

It is an object of the present teachings to provide an unmanned aerial vehicle which is capable of substantially vertical takeoff and/or substantially vertical landing, low-speed maneuverability, and high-speed flight.

It is an object of the present teachings to provide an unmanned aerial vehicle which maintains its fuselage at a substantially constant attitude during flight. Such a UAV is beneficial in stabilizing a payload carried by the UAV while in flight.

It is an object of the present teachings to provide an unmanned aerial vehicle which protects avionics, sensitive equipment, and/or payloads onboard the vehicle from turbulence and other vibrations during flight, especially at high speeds.

These and other objects of the present teachings are achieved by providing an unmanned aerial vehicle which comprises a fuselage having a forward end, an aft end, and a duct extending between the forward end and the aft end, the duct being oriented along a longitudinal axis of the fuselage. The aerial vehicle also comprises a primary propulsion unit mounted within the duct and generating lift for upward and downward motion while the fuselage is in a substantially vertical orientation and thrust for forward motion while the fuselage is in a substantially horizontal orientation. The aerial vehicle is equipped with a plurality of airfoils each having a proximal end attached at opposite sides of the fuselage, the airfoils providing lift during forward motion of the fuselage. The aerial vehicle also comprises a plurality of secondary propulsion units generating thrust to tilt the fuselage between the substantially vertical orientation and the substantially horizontal orientation.

The present teachings also provide an aerial vehicle comprising: a fuselage having a forward end, an aft end, and a body extending between said forward end and said aft end along a longitudinal axis of said fuselage; at least one primary propulsion unit mounted in said body and generating lift for upward and downward motion while said fuselage is in a substantially vertical orientation and thrust for forward motion while said fuselage is in a substantially horizontal orientation; a plurality of airfoils each having a proximal end attached at opposite sides of the fuselage, said airfoils providing lift during forward motion of said fuselage; and a plurality of secondary propulsion units generating thrust to tilt the fuselage between said substantially vertical orientation and said substantially horizontal orientation.

The present teachings further provide an aerial vehicle comprising: a fuselage having a forward end, an aft end, and a body extending between said forward end and said aft end; a plurality of propulsion units attached to said fuselage and generating thrust for translational motion of said fuselage; and a plurality of airfoils each having a proximal end attached at opposite sides of the fuselage via a pivot joint, said airfoils being pivotable to adjust an angle of incidence of said airfoils relative to said fuselage to provide lift during translational motion of said fuselage.

Other features and aspects of the present invention will become apparent from the following detailed description, taken in conjunction with the accompanying drawings, which illustrate by way of example the features in accordance with embodiments of the invention. The summary is not intended to limit the scope of the invention, which is defined solely by the claims attached thereto.

### BRIEF DESCRIPTION OF THE DRAWINGS

FIGS. 1A-1C are perspective views of an unmanned aerial vehicle according to the present teachings. FIG. 1A, in particular, shows the unmanned aerial vehicle in a configuration and orientation for vertical takeoff and landing. FIGS. 1B-1C, in particular, show the unmanned aerial vehicle in forward flight with different payload configurations.

FIGS. 2A-2B are simplified views of the unmanned aerial vehicle in FIGS. 1A-1C, illustrating the main force generating components of the vehicle.

FIGS. 3A-3B are simplified views of bidirectional/omnidirection wings and wing loading control, which are present in the unmanned aerial vehicle in FIGS. 1A-1C.

FIGS. 4A-4D are simplified views of bidirectional/omnidirection wings of the unmanned aerial vehicle in FIGS. 1A-1C with wing loading control.

FIGS. 5A-5B show a perspective view, and a corresponding enlarged partial view, of the unmanned aerial vehicle in FIGS. 1A-1C, illustrating internal components within the fuselage of the vehicle.

FIG. 6A-6B show a perspective view of the unmanned aerial vehicle in FIGS. 1A-1C, illustrating a reactive thrust stabilization system.

FIG. 7A-7B show the technology concept and application of the aerial vehicle of FIGS. 1A-1C.

It should be understood that through the drawings, corresponding reference numerals indicate like or corresponding parts and features.

### DETAILED DESCRIPTION

The present teachings are described more fully hereinafter with reference to the accompanying drawings, in which the present embodiments are shown. The following description illustrates the present teachings by way of example, not by way of limitation of the principles of the present teachings.

The present teachings have been described in language more or less specific as to structural features. It is to be understood, however, that the present teachings are not limited to the specific features shown and described, since the devices herein disclosed comprise preferred forms of putting the present teachings into effect.

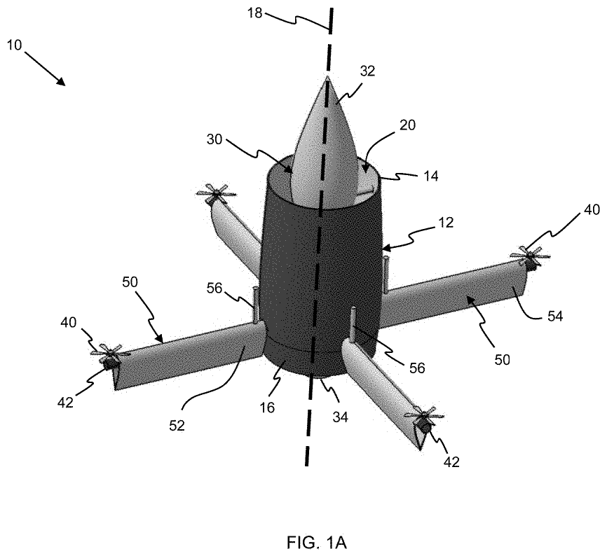

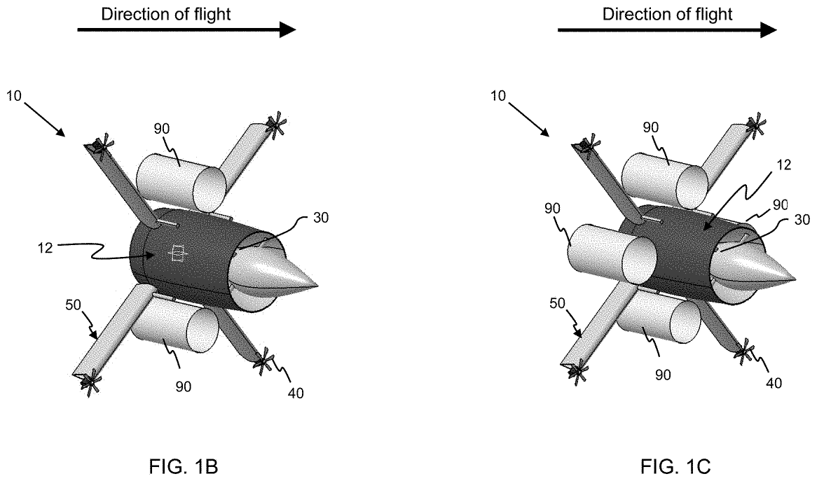

Referring to FIGS. 1A-1C, an aerial vehicle 10, such as a UAV, according to the teachings is shown. The aerial vehicle is designed for vertical takeoff and landing (VTOL), and thus is able to depart from and/or arrive in confined spaces. This particular feature is advantageous for payload or package delivery, especially in the presence of buildings, structures, humans, and other obstacles (e.g., power lines, communication lines, etc.). The aerial vehicle 10 includes a fuselage 12 for holding avionics, including guidance, navigation, and/or control systems. The fuselage 12 has a forward end 14 and an aft end 16, and is defined by a longitudinal axis 18. In some embodiments, the fuselage 12 has, but is not limited to, a substantially cylindrical shape. The aerial vehicle is designed to switch between different configurations and/or orientations depending on the phase of flight of the aerial vehicle. As shown in FIG. 1A, the fuselage 12 is in a substantially vertical orientation (e.g., the longitudinal axis 18 is substantially vertical relative to the horizon) during takeoff (initial climb) and/or landing, as well as while the vehicle is hovering in a relatively stationary position (e.g., latitude, longitude, and/or altitude). The aerial vehicle may also maintain or shift into the vertical orientation during other phases of flight, including climb (ascent), descent, initial approach, and/or final approach. FIGS. 1B-1C show the fuselage 12 in a substantially horizontal orientation (e.g., the longitudinal axis 18 is substantially horizontal relative to the horizon). The aerial vehicle is configured to switch into this state for the cruise phase, which may account for the majority of the flight and may include changes in heading (direction of flight) at a constant airspeed and altitude. In some situations, the substantially horizontal state may be used during the ascent and descent phases of flight. In yet other situations, the fuselage may be in a hybrid or transition state between the substantially vertical and substantially horizontal states for the ascent and descent phases. The mechanism for the aerial vehicle to transition between the two states is discussed further below.

A duct 20 extends through the fuselage along the longitudinal axis from the forward end to the aft end, allowing for air to pass through the fuselage. In some embodiments, the duct 20 may have a constant diameter throughout its entire length from the forward end to the aft end of the fuselage. In other embodiments, the diameter of the duct may vary along its length in order to better direct airflow. For example, the diameter of the duct at a forward portion of the fuselage may initially decrease towards a middle portion and subsequently increase towards the aft portion of the fuselage. As another example, the duct may be configured so that its diameter at the forward portion may increase towards the middle portion and subsequently increase towards the aft portion. It will be readily understood that different diameter configurations may also be utilized to form the duct in the fuselage as will be readily understood by a person of ordinary skill in the art.

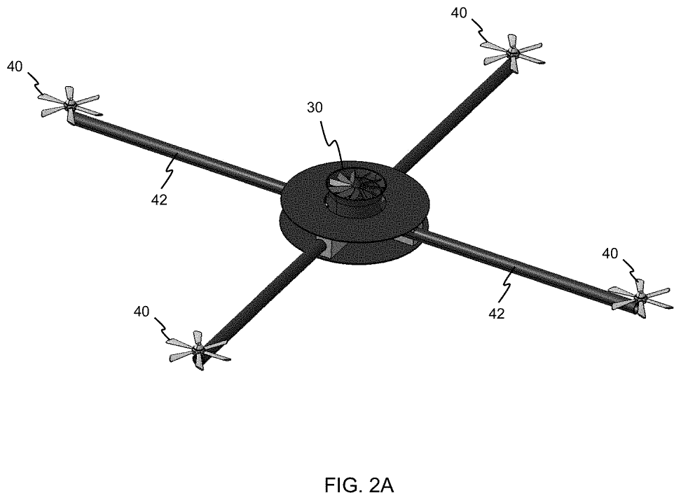

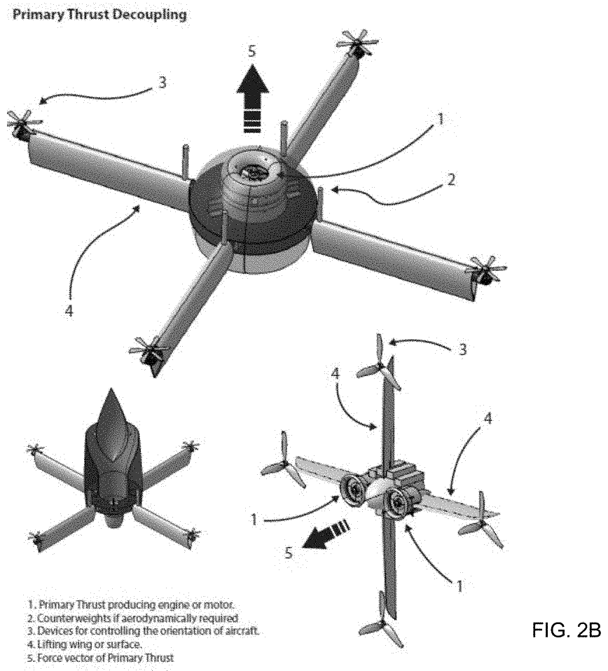

The aerial vehicle 10 includes at least one primary propulsion unit 30 mounted in the fuselage 12, and more specifically within the duct 20. The primary propulsion unit is configured to produce the majority of the propulsion force of the aerial vehicle, for example more than 50%, 60%, 70%, 80%, or 90% of the propulsion force. While the fuselage is in the substantially vertical orientation (FIG. 1A), the primary propulsion unit 30 generates upward pushing force or thrust that overcomes the weight of the aerial vehicle (and any payloads and/or packages carried by the aerial vehicle). The propulsion unit 30 therefore generates lift for upward and downward motion of the fuselage. When the fuselage is in the substantially horizontal orientation (FIGS. 1B-1C), the primary propulsion unit 30 generates thrust to propel the aerial vehicle in a forward direction of motion. The primary propulsion unit is capable of propelling the aerial vehicle at much higher speeds than conventional rotor-based UAVs. As shown in FIGS. 2A-2B, the primary propulsion unit may comprise an electric-based or fuel-based turbine engine 30. However, in other embodiments, the primary propulsion unit may comprise other thrust generating devices, including but not limited to electrically or fuel driven propellers, ducted propellers, ducted fans, compressors, jet engines (e.g., turbojet, turbofan). The primary propulsion unit 30 is positioned within the fuselage to provide static and/or dynamic lifting (upward/downward) and forward (direction of movement) thrust, depending on the state of the aerial vehicle. In some embodiments, the aerial vehicle 10 may include multiple primary propulsion units to produce the majority of the propulsion force of the aerial vehicle. The multiple primary propulsion units may each be mounted within the same duct 20. Alternatively, the aerial vehicle may be designed to include multiple parallel ducts, each equipped with its own primary propulsion unit. Other embodiments of the aerial vehicle may not have any ducts and may provide one or more primary propulsion unit(s) on the exterior of the fuselage.

Referring to FIGS. 2A-2B, the primary propulsion unit 30 is configured for thrust decoupling. That is, the primary propulsion unit provides un-vectored thrust and is not dynamically vectored. The direction of the thrust vector is determined by the position and orientation of the propulsion unit 30 mounted within the fuselage 12. The orientation of the primary propulsion unit is controlled independently from the exhaust thrust that the primary propulsion unit produces. The primary propulsion unit is adapted to produce from 0 to over 100% of the aircraft's gross weight in its performance of lifting (upward/downward) and driving the vehicle forward. Accordingly, the design and configuration of the primary propulsion unit allow for all the lift to be achieved through un-vectored thrust. While in the substantially vertical orientation, the position of the aerial vehicle in space is not controlled by vectoring thrust of the primary propulsion unit 30. Instead, directional movement as well as rotation of the aerial vehicle (during the substantially vertical state) is controlled by forces produced by one or more secondary propulsion units 50. In some embodiments however, the primary propulsion unit 30 may provide thrust vectoring, such that the aerial vehicle has the capacity to manipulate the direction of the thrust generated from the propulsion unit 30 in order to control the attitude, directional movement (forward, backwards, side-to-side), and/or rotation of the fuselage. The primary propulsion unit 30 may also be configured for hybrid operation. The primary propulsion unit may work in cooperation with other systems of the vehicle that controls the orientation of the aircraft (e.g., secondary propulsion units 50) in order to increase the total aircraft thrust, regardless of the direction of thrust.

Referring back to FIGS. 1A-1C, the primary propulsion unit may comprise a central or inlet cone 32 to direct the flow of air and adjust the rate of airflow before entering the propulsion unit. In addition, or alternatively, the primary propulsion unit may comprise an outlet or exhaust cone 34. The exhaust cone attaches to the rear of the primary propulsion unit and is tapered, cone-shaped to collect the gases that are discharged from the propulsion unit and convert them into a single jet.

The aerial vehicle 10 also comprises a plurality of secondary propulsion units 40 (e.g., two, three, four, etc.) that generate thrust to tilt the fuselage between the substantially vertical orientation (FIG. 1A) and the substantially horizontal orientation (FIGS. 1B-1C). The secondary propulsion units are positioned off to the sides of the fuselage 12. In particular, the aerial vehicle includes structural arms 42 that extend in an outward direction away from the sides of the fuselage, and the secondary propulsion units 40 are mounted to the distal ends of the arms 42, as shown in FIG. 2A. An axis of each arm may be oriented perpendicular to a tangent of the surface of the fuselage. In some embodiments, the secondary propulsion units 30 comprise rotors or propellers to generate thrust. However, in other embodiments, the secondary propulsion units may comprise other thrust-generating devices.

The secondary propulsion units 40 are mounted to the arms so that the propulsion units have rotational axes that are substantially parallel to each other and that are substantially parallel to the longitudinal axis 18 of the fuselage. With this configuration, the secondary propulsion units provide additional thrust (in combination with the thrust generated by the primary propulsion unit 30) for the aerial vehicle. For example, when the fuselage is in the substantially horizontal orientation (FIGS. 1B-1C), the secondary propulsion units 40 provide additional thrust for translational motion (forward motion) of the aerial vehicle. The combination of the primary and secondary propulsion units therefore enables the vehicle to obtain forward motion with a wide range of speeds from low speed to very high speeds (compared to conventional rotor-based UAVs). On the other hand, when the fuselage is in the substantially vertical orientation (FIG. 1A), the secondary propulsion units 40 are configured to generate lift for upward and downward motion or hovering of the aerial vehicle. The combination of the primary and secondary propulsion units therefore enables the vehicle to generate enough lift to overcome the weight of the aerial vehicle plus any heavy payloads or packages carried by the aerial vehicle. The aerial vehicle according to the present teachings is capable of taking off/ascending and descending/landing with heavy weight payloads (e.g., greater than 10 lbs., greater than 20 lbs, etc.). As such, the aerial vehicle may be characterized as a heavy lift aerial vehicle. Additionally, while in the substantially vertical state, the secondary propulsion units 40 can generate a net force on the fuselage 12 through the arms 42 in order to control directional movement (forward, backwards, side-to-side) of the fuselage and/or to generate a torque to rotate the fuselage around its longitudinal axis 18.

The aerial vehicle 10 includes a plurality of airfoils 50 (e.g., two, three, four, etc.) which are attached at their proximal ends 52 to the fuselage 12. In particular, the airfoils are mounted around the structural arms 42, and thus the airfoils extend in an outward direction from the proximal ends 52 to distal ends 54 away from the fuselage. The airfoils are attached at opposing sides of the fuselage. For example, if the aerial vehicle has two airfoils, then they are mounted to be coplanar on opposite sides of the fuselage. If the aerial vehicle has three airfoils, then they are mounted around the fuselage in a Y-configuration (separated by 120 degrees). Alternatively, if there are four airfoils, then they may be mounted in a cruciform or X-configuration (separated by 90 degrees). As shown in FIGS. 1B-1C, the airfoils 50 provide lift during translational motion (e.g., forward motion) of the vehicle, i.e., while the primary propulsion unit 30 (and possibly the secondary propulsion units 40) provides thrust as the fuselage is in the substantially horizontal state. The airfoils may comprise, but are not limited to, wings.

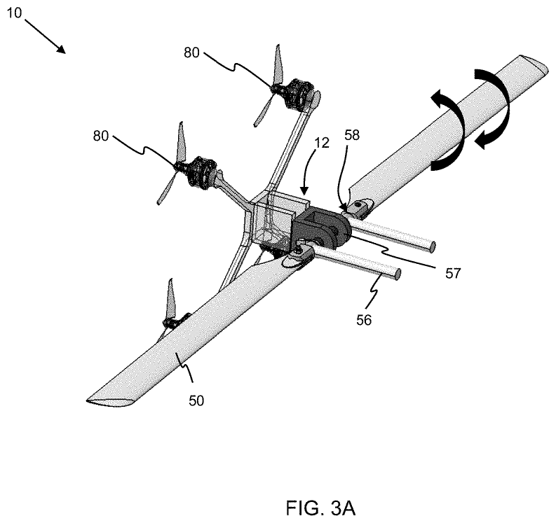

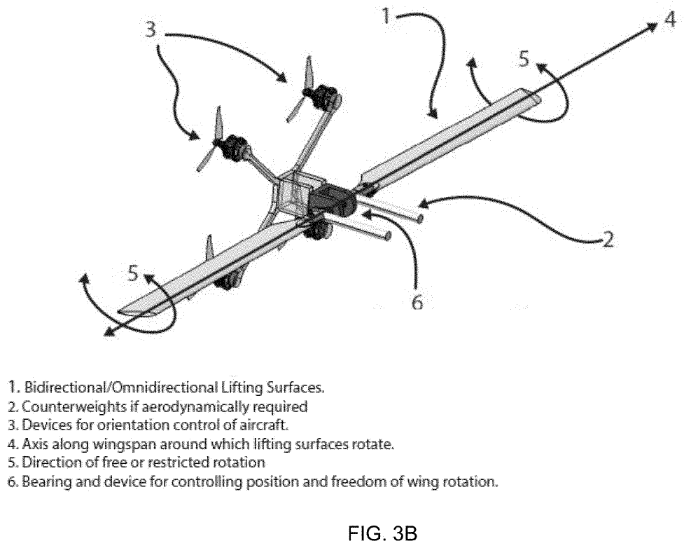

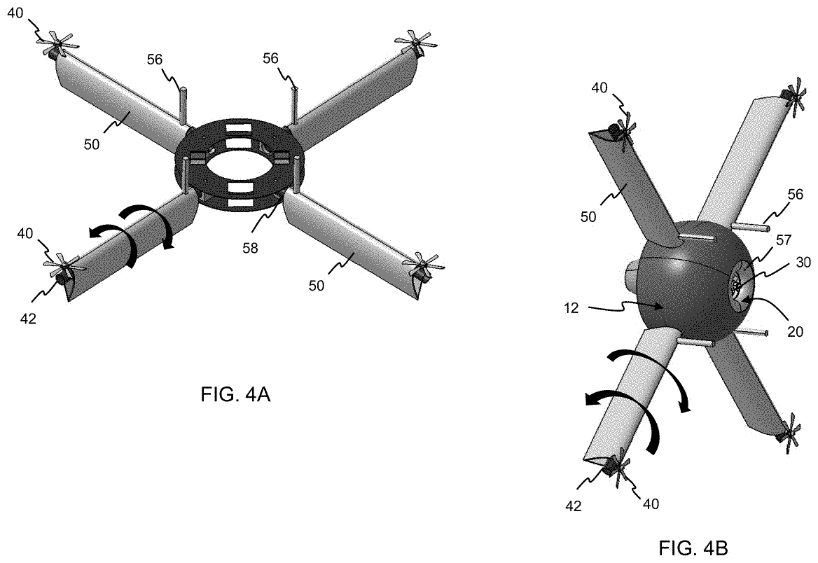

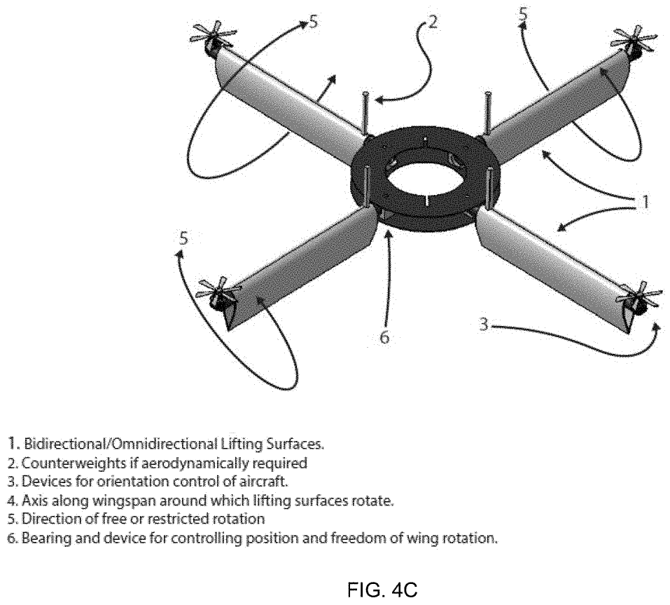

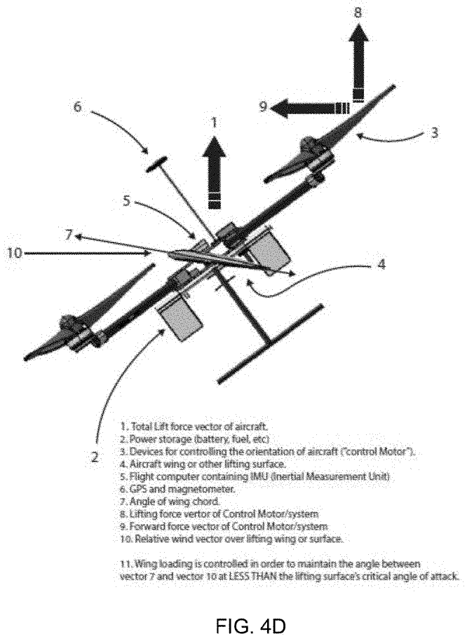

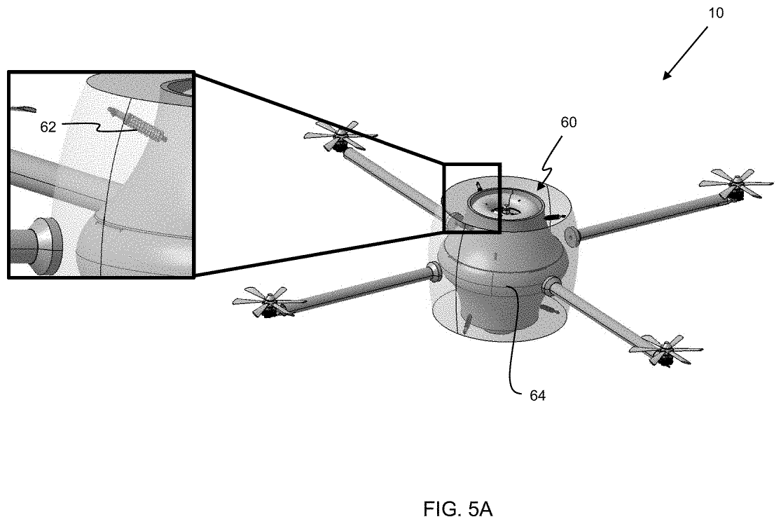

In some embodiments, the mounting of the airfoils 50 to the arms 42 includes a pivot joint so that each airfoil is designed to pivot around the axis of the respective arm 42. The airfoil accordingly is pivotable around the respective arm in order to adjust an angle of incidence of the respective airfoil relative to the fuselage (longitudinal axis of the fuselage), as shown in FIGS. 3A-3B and 4A-4D. The airfoils are free to rotate or are rotatable into an angular position that is optimal for current flight conditions and/or for the particular phase of flight the aerial vehicle is in. Aerodynamic forces may act on the airfoils and readily adjust their orientation. In some embodiments, during forward motion of the aerial vehicle (fuselage is in substantially horizontal orientation), the airfoils 50 are adjustable so that the angle of attack relative to airflow may be varied while the fuselage remains at a steady attitude. For example, during forward motion of the aerial vehicle, the airfoils are adjustable to decrease loading on said airfoils to a point where the total lifting force of the aerial vehicle induces an angle of attack less than or equal to the critical angle of attack of said airfoils. The angular position/orientation of each airfoil is decoupled or independent of the orientation of the fuselage and the position of the aerial vehicle in space. The airfoils does not have to point in the exact direction of forward motion. The term “steady attitude” means a substantially constant attitude including deviations caused by turbulence and/or wind gusts, as will be readily understood by a person of ordinary skill in the art.

A wing loading control system is included in the aerial vehicle is designed to orient the airfoils into optimal angular positions for any particular flight condition. In some embodiments, each airfoil is equipped with a counterbalance mechanism 56 to provide passive adjustment of the respective airfoil's angular position/orientation. The counterbalance mechanism may comprise a weight that extends out, e.g., perpendicular relative to, a leading edge of the respective airfoil (FIGS. 3A-3B and 4A-4D). In addition, or alternatively, the counterbalance mechanism may comprise a spring connected between the airfoil 50 and the fuselage 12 or arm 42, wherein the spring holds the airfoil position in place. In addition to or alternatively to the counterbalance mechanism, wing loading may be actively controlled by a computer, processing device, and/or avionics within the fuselage, which maintains the airfoils in an un-stalled state through the vehicle's flight envelope. The wing loading control system may include one or more sensors for measuring flight characteristics (e.g., airspeed, angle of attack, angle of incidence, static pressure, total pressure, etc.) and a plurality of actuators for pivoting the airfoils relative to the fuselage, wherein the computer or processing device adjusts the airfoils via the actuators based on the sensor measurements. The maintenance of the airfoils or wings in an un-stalled state is achieved by decreasing the wing-loading while the vehicle is in the air to the point where the lifting force produced by airfoils, in combination with the total lifting force provided by other systems on the aircraft, induce an angle of attack, less than or equal to the critical angle of attack (the point at which the airfoils stall), of the airfoils. When active wing-loading is utilized by the aerial vehicle, the total lifting (upward) force the aircraft produces is the vector sum of the lift produced by the airfoils combined with the total lift of all other upward thrust vectors. Active wing-loading allows the airfoils on the vehicle to contribute to the total lifting force the aircraft generates throughout a very wide range of flight speeds. Active wing-loading allows the airfoils to contribute to the total lifting force produced by the aircraft, anytime the airmass is moving relative to the aircraft, as is the case when hovering over a fixed group position in windy conditions. While primarily controlled by the active manipulation of wing-loading, other factors that impact the critical angle of attack of the airfoils may be employed. These include but are not limited to changing the angle of the wing chord, as well as the employment of devices such as flaps and slats that alter the airfoil. In all cases, however, wing loading continues to control the magnitude of the load of the aircraft on the airfoils such that the airfoil's contribution of lift to the aerial vehicle does cause the aircraft to move through the airmass in a direction that would result in an angle of attack greater than the airfoil's angle of attack.

The airfoils (e.g., wings, wing-like structures) are bidirectional/omnidirectional in that the chord of the airfoils may rotate freely around an axis roughly parallel to the span of the wing, such that the wing is capable of generating lift forward or backward relative to its chord. This rotation may be any angle up to and including 360 degrees (i.e. full rotation). The omnidirectional airfoils may self-position via aerodynamic forces both in combination with other control devices, and without. Other non-aerodynamic force positioning devices that may be employed include passive devices, such as springs and levers (counterweight 56), and active devices such as servos 58. Bidirectional/Omnidirectional airfoils are de-coupled from one or more axes of the aircraft, allowing them to seek a position consistent with generating lift in the direction of flight. The bidirectional/omnidirectional lifting surfaces may work in combination with active wing loading so that regardless of position, the airfoil, is maintained in an un-stalled flight condition with its angle of attack less than its critical angle of attack. The bidirectional/omnidirectional airfoils may comprise any number of wings or lifting surfaces. These wings may rotate together, in pairs, or independently depending on physical setup. The airfoils are generally symmetrical about their chord but, in certain special cases, they may non-symmetrical shape.

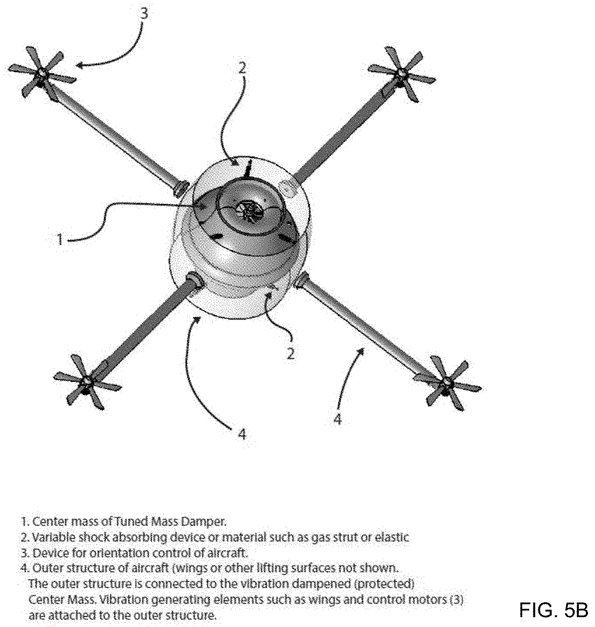

Referring to FIGS. 5A-5B, the interior of the fuselage 12 is shown. Within the fuselage, the aerial vehicle comprises a vibration management system 60, which is configured to limit or damp transmission of vibrations from flights surfaces of the aerial vehicle to avionics and/or payloads disposed within the fuselage. This will help protect the avionics and/or payloads which may be sensitive to vibrations. The damping system is especially beneficial when the aerial vehicle is traveling at high speeds and/or in turbulent environments. It is known to a person of ordinary skill in the art that aircraft vibrations during flight is not unusual, and that vibrations increase with increasing speed of the aerial vehicle. In some embodiments, the vibration management system may comprise a tuned mass damper aircraft IMU (inertial measurement unit) vibration management system, which includes inertial measurement instruments and/or other computerized instruments on the aerial vehicle. This system involves the mounting of the relatively higher-mass elements of the aerial vehicle together, approximately at the vehicle's center of mass 64 and couple this mass to the primary vibration sources such as wings and propellers via a “tunable” system of vibration-dampening (variable shock absorbing) devices including but not limited to, flexible couplings and compressible materials, gas or fluid shock absorbers and/or gas struts, which are collectively identified by reference number 62. The mass damper 64 may be “tuned” by varying the compression and coefficients of elasticity of the coupling devices relative to the inherent vibration frequency of the aerial vehicle. The tuned mass damper may also be tuned by changing the mass of the damper itself. The aerial vehicle's innate critical vibrational frequencies are a complex function of the structure and mass of the aircraft and may be determined experimentally. The central mass of the tuned mass damper in the vehicle comprises, but is not limited to, one or more of the following “massive” components: core/primary propulsion system (if present), power supply (e.g., batteries and/or fuel), and electronic speed controllers. The central mass of the tuned mass damper in the aerial vehicle also includes the sensitive avionics and system components that are to be protected from extreme vibration. The central mass is coupled to the vibration generating airfoils 40 (wings and lifting surfaces), motors/engines, the aircraft's orientation control system, and propellers (if present), as well as other external electronics not sensitive to vibration such at antennas and transmitters. The central mass may or may not also include the payload of the aircraft (if present) depending on whether the payload is particularly sensitive to vibration.

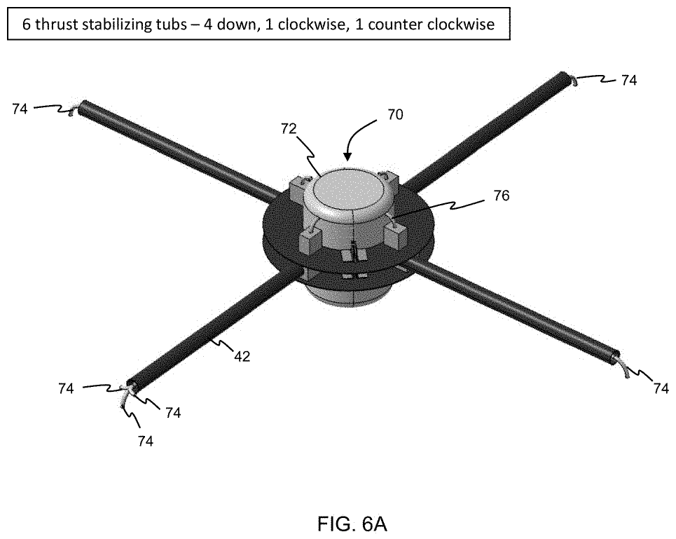

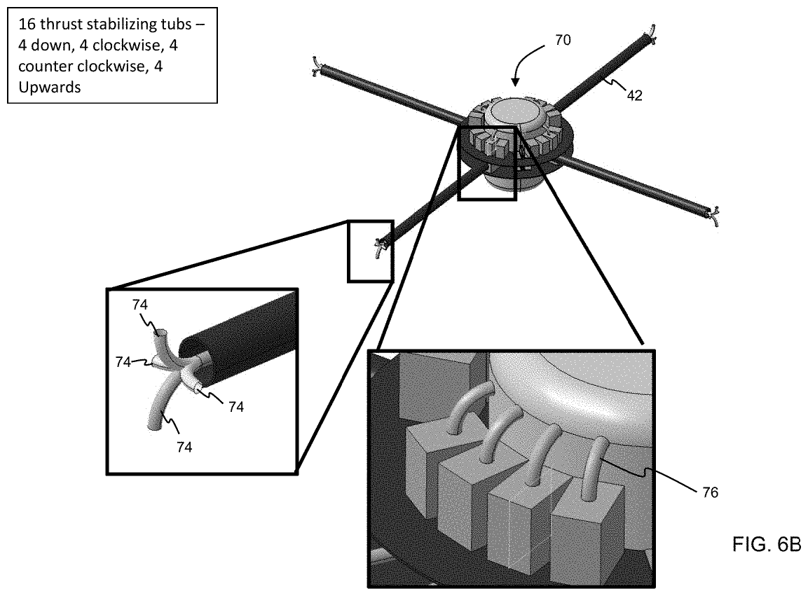

Referring to FIGS. 6A-6B, the aerial vehicle may comprise a reactive thrust stabilizing system 70 which helps to minimize retreating/retracting blade stall conditions. The stabilizing system comprises a pressure source 72 containing a gas (e.g., air). The pressure source, which is disposed within the fuselage, may comprise a bladder pressurized by a pump or a compressor in the turbine, or taps in the high-pressure stage of the turbine (primary propulsion unit 30) in order to supply the gas at high pressure through a plurality of pressure tubes 74. As shown in FIGS. 6A-6B, each pressure tube 74 extends from the proximal end to the distal end of one of the airfoils 50, and more specifically, extend through a channel formed within the respective structural arm 42. Accordingly, the pressure tubes supply or eject high pressure gas at the distal end of the structural arm 42. The ejection of high pressure gas, in turn, provides for thrust vectoring for the aerial vehicle. The aerial vehicle may include multiple solenoids 76 to regulate the flow of gas from the pressure source to the pressure tubes. The solenoids, for example, may be an on-off type (open-close) or may provide variable flow rate. FIG. 6A, in particular, shows 6 thrust stabilizing tubs (pressure tubes), four oriented in a downward direction, one oriented in a clockwise direction, and one oriented in a counter-clockwise direction. The solenoids may be connected to tapes in the high-pressure stage of the turbine or to a small bladders, pressurized by a pump. FIG. 6B, in particular, shows 16 thrust stabilizing tubs (pressure tubes), four oriented in a downward direction, four oriented in a clockwise direction, four oriented in a counter-clockwise, and four oriented in an upwards direction.

Referring back to FIGS. 1B-1C, the aerial vehicle may be equipped with one or more storage compartments 90 for carrying payload or packages. These storage compartments may be mounted to the exterior sides of the fuselage 12. The storage compartments may releasably attached or be permanently fixed to the fuselage. In some embodiments, the storage compartment may comprise the payload or the package.

Some embodiments of the aerial vehicle may not have two sets of propulsion units (primary 30 and secondary 40), and instead have only one set of propulsion units. As shown in FIGS. 3A-3B, the aerial vehicle 10 includes a plurality of propulsion units 80 that generate thrust for forward motion of the aerial vehicle. Similar to the aerial vehicle shown in FIGS. 4A-4D and 5, the aerial vehicle of FIG. 3 is configured with wing loading control, omnidirectional/bidirectional airfoils, and/or a vibration management system as discussed in detail above.

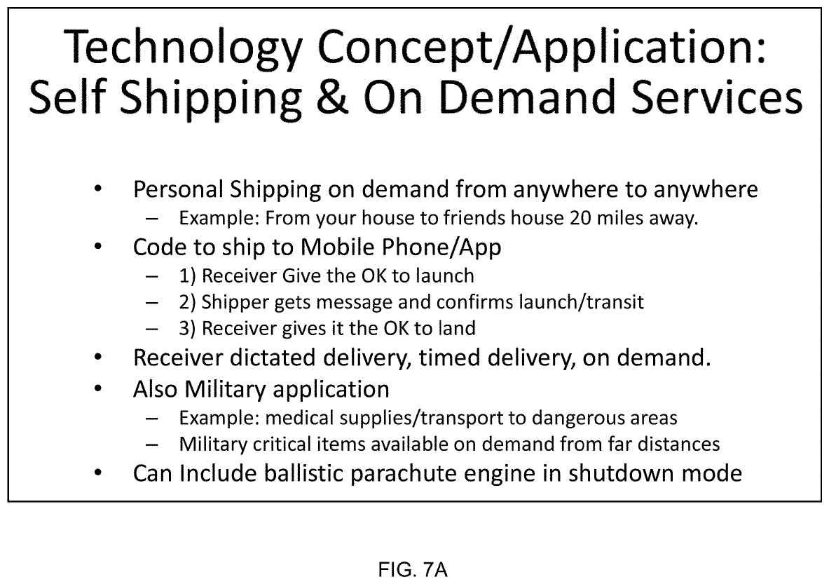

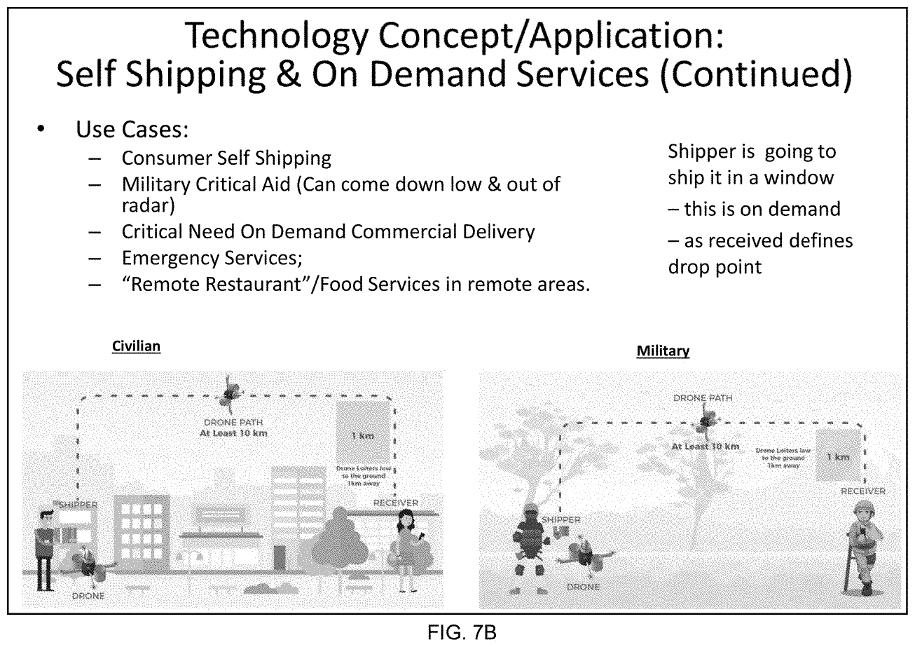

The present teachings also provide a payload/package shipping system, which provides for self-shipping and on-demand services (FIG. 7A). The system allows for personal shipping on demand from any location to any destination, for example from your house to a friend's house 20 miles away. In particular, the system may be configured to function with a code to ship to a recipient's mobile phone (through a mobile application). The recipient can provide a confirmation (confirmation signal) indicating that it is ok to proceed with delivering the package via the aerial vehicle 10. The shipper receives the recipient's confirmation and initiates the delivery of the package. The shipper then sends a verification signal to the recipient indicating that the aerial vehicle has departed and is in transit to the recipient's location (or to delivery address). Finally, upon the aerial vehicle approaching the delivery location, the recipient will provide a “clear to land” signal to the vehicle, at which point the vehicle will land. With the payload/package shipping system, the recipient dictates delivery, can schedule a timed delivery, and provide on demand shipping instructions. This system also has military applications. For example, this system can transport medical supplies to conflict areas and/or other dangerous areas, and also provide critical items (e.g., medical equipment, communications equipment, weapons, ammunition) available on demand from far distances. In some embodiments, the system may comprise a ballistic parachute engine in shutdown mode.

With the aerial vehicle according to the present teachings, various use cases are possible, including consumer self-shipping, military critical aid (e.g., vehicle can fly low and outside range of radar detection), critical need on demand commercial delivery, emergency services, and “remote restaurant” food services in remote areas (FIG. 7B).

It should be understood to a person of ordinary skill in the art that different configurations of the unmanned aerial vehicle are possible. For example, the layout of the turbine engine, rotors, speed controllers, sensors, and/or other internal component may differ from those shown in the Figures without departing from the scope and spirit of the present teachings. The components included in the unmanned aerial vehicle and/or arrangement of components in the payload delivery system may differ from that shown in the Figures without departing from the scope and spirit of the present teachings.

While the present teachings have been described above in terms of specific embodiments, it is to be understood that they are not limited to those disclosed embodiments. Many modifications and other embodiments will come to mind to those skilled in the art to which this pertains, and which are intended to be and are covered by both this disclosure and the appended claims. For example, in some instances, one or more features disclosed in connection with one embodiment can be used alone or in combination with one or more features of one or more other embodiments. It is intended that the scope of the present teachings should be determined by proper interpretation and construction of the appended claims and their legal equivalents, as understood by those of skill in the art relying upon the disclosure in this specification and the attached drawings.

What is claimed is:

1. An aerial vehicle, comprising:
a fuselage having a forward end, an aft end, and a duct extending between said forward end and said aft end, said duct being oriented along a longitudinal axis of said fuselage;
a primary propulsion unit mounted within said duct and generating lift for upward and downward motion while said fuselage is in a substantially vertical orientation and thrust for forward motion while said fuselage is in a substantially horizontal orientation;
a plurality of airfoils each having a proximal end attached at opposite sides of the fuselage, said airfoils providing lift during forward motion of said fuselage; and
a plurality of secondary propulsion units generating thrust to tilt the fuselage between said substantially vertical orientation and said substantially horizontal orientation.

2. The aerial vehicle of claim 1, wherein said secondary propulsion units also generate lift for upward and downward motion while said fuselage is in said substantially vertical orientation.

3. The aerial vehicle of claim 2, wherein said secondary propulsion units are configured to generate thrust for directional movement of said fuselage while in said substantially vertical orientation.

4. The aerial vehicle of claim 2, wherein said secondary propulsion units are configured to generate torque to rotate said fuselage while in said substantially vertical orientation.

5. The aerial vehicle of claim 1, further comprising a plurality of arms extending out from said opposite sides of the fuselage, each airfoil being mounted around one of said arms, wherein each secondary propulsion unit is mounted to a distal portion of one of said arms.

6. The aerial vehicle of claim 5, wherein each airfoil is pivotable around said respective arm in order to adjust an angle of incidence of said respective airfoil relative of said fuselage.

7. The aerial vehicle of claim 6, wherein during said forward motion, said airfoils are adjustable to decrease loading on said airfoils to a point where the total lifting force of said aerial vehicle induces an angle of attack less than or equal to the critical angle of attack.

8. The aerial vehicle of claim 7, wherein each airfoil includes a counterbalance mechanism that provides passive adjustment of said respective airfoil.

9. The aerial vehicle of claim 7, further comprising a wing loading control system that pivots the airfoils via a plurality of actuators based on measurements of at least one flight characteristic.

10. The aerial vehicle of claim 1, further comprising a vibration damping system within said fuselage, said vibration damping system limits transmission of vibrations from said secondary propulsion units to avionics disposed within the fuselage.

11. The aerial vehicle of claim 1, further comprising a reactive thrust stabilizing system that minimizes retreating blade stall conditions.

12. The aerial vehicle of claim 11, wherein said reactive thrust stabilizing system comprises at least one pressure source disposed within said fuselage and a plurality of pressure tubes each extending from the proximal end to a distal end of one of the airfoils, said pressure tubes transmitting high pressure gas from the pressure source for use in controlling flight surfaces in the airfoil.

13. The aerial vehicle of claim 1, wherein said airfoils comprise wings.

14. The aerial vehicle of claim 1, wherein the proximal ends of the airfoils are attached to an aft section of the fuselage.

15. The aerial vehicle of claim 1, wherein the primary propulsion unit comprises a turbine engine.

16. An aerial vehicle, comprising:
a fuselage having a forward end, an aft end, and a body extending between said forward end and said aft end;
at least one primary propulsion unit mounted in said body and generating lift for upward and downward motion while said fuselage is in a substantially vertical orientation and thrust for forward motion while said fuselage is in a substantially horizontal orientation;
a plurality of airfoils each having a proximal end attached at opposite sides of the fuselage, said airfoils providing lift during forward motion of said fuselage; and
a plurality of secondary propulsion units generating thrust to tilt the fuselage between said substantially vertical orientation and said substantially horizontal orientation.

17. The aerial vehicle of clam 16, wherein said secondary propulsion units work in cooperation with said at least one primary propulsion unit to increase total thrust of said vehicle.

18. The aerial vehicle of claim 16, wherein said secondary propulsion units work in cooperation with said at least one primary propulsion unit to increase total lift of said vehicle for upward and downward motion while said fuselage is in said substantially vertical orientation.

19. The aerial vehicle of claim 16, further comprising a storage compartment mounted to said fuselage, said storage compartment being adapted to carry a payload or package.

20. An aerial vehicle, comprising:
a fuselage having a forward end, an aft end, and a body extending between said forward end and said aft end;
a plurality of propulsion units attached to said fuselage and generating thrust for translational motion of said fuselage; and
a plurality of airfoils each having a proximal end attached at opposite sides of the fuselage via a pivot joint, said airfoils being pivotable to adjust an angle of incidence of said airfoils relative to said fuselage to provide lift during translational motion of said fuselage.

21. The aerial vehicle of claim 20, wherein said airfoils comprise wings that are configured to pivot 360 degrees relative to said fuselage.

22. The aerial vehicle of claim 20, wherein during said translational motion, said airfoils are adjustable to decrease loading on said airfoils to a point where a total lifting force of said aerial vehicle induces an angle of attack less than or equal to the critical angle of attack.
